(19) United States
(12) Patent Application Publication
(10) Pub. No.: US 2012/0036451 A1
(43) Pub. Date: Feb. 9, 2012

(54) ELECTRONIC DEVICE AND METHOD FOR FACILITATING RECORDING MEETING CONTENTS

(75) Inventors: CHUN-WEN WANG, Tu-Cheng (TW); CHIEN-HUANG CHANG, Tu-Cheng (TW); CHI-FAN HO, Tu-Cheng (TW)

(73) Assignee: HON HAI PRECISION INDUSTRY CO., LTD., Tu-Cheng (TW)

(21) Appl. No.: 13/103,119

(22) Filed: May 9, 2011

(30) Foreign Application Priority Data
Aug. 9, 2010 (CN) 201010248373.2

(51) Int. Cl. G06F 3/048

(52) U.S. Cl. 715/748; 715/847

(57) ABSTRACT

An electronic device includes a screen, a processor, and a storage unit. The storage unit stores one or more computerized instructions. The storage unit includes a meeting user interface (UI) module. The meeting UI module includes a meeting information display sub-module and an application control sub-module. The meeting information display sub-module is may display meeting subject item, an attendee contact list, and a file list on a desktop of the display screen. The application control sub-module may display shortcuts on the desktop of the display screen. The shortcuts are associated with a voice recording application, a note application, and a task editing application.

### BACKGROUND

1. Technical Field

The disclosure generally relates to an electronic device for facilitating recording meeting contents.

2. Description of Related Art

When at a meeting, an assistant electronic device is usually employed for recording content of the meeting to facilitate review of the meeting after the meeting is over. However, the assistant electronic device may have limited functions such as audio recording, video recording, storing files, or a member contact list. Thus, an electronic device is needed to facilitate recording meeting content.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic device in one embodiment.

FIG. 2 is a view of a meeting user interface (UI) with a meeting notice.

FIG. 3 is a view of the meeting UI on a desktop of a screen.

FIG. 4 is a view of the meeting UI with an edit window of a meeting subject item.

FIG. 5 is a view of the meeting UI with detail contact list.

FIG. 6 is a view of the meeting UI with detail file list.

FIG. 7 is view of the meeting UI with a task list.

FIG. 8 is view of the meeting UI with detail task information.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

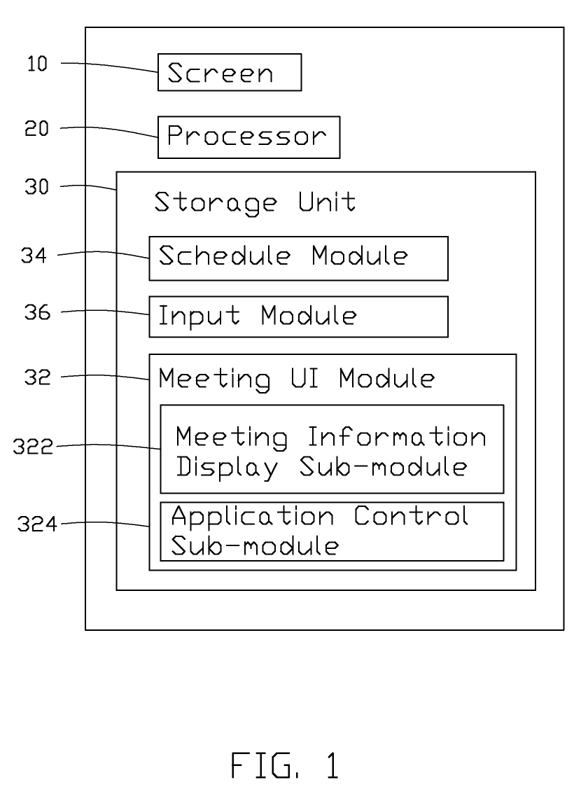

Referring to FIG. 1, in one embodiment, an electronic device includes a screen 10, a processor 20, and a storage unit 30. The electronic device may be a portable electronic device, such as a smart phone. The screen 10 may be a touch-sensitive screen. The storage unit 30 includes a meeting user interface (UI) module 32, a schedule module 34, and an input module 36.

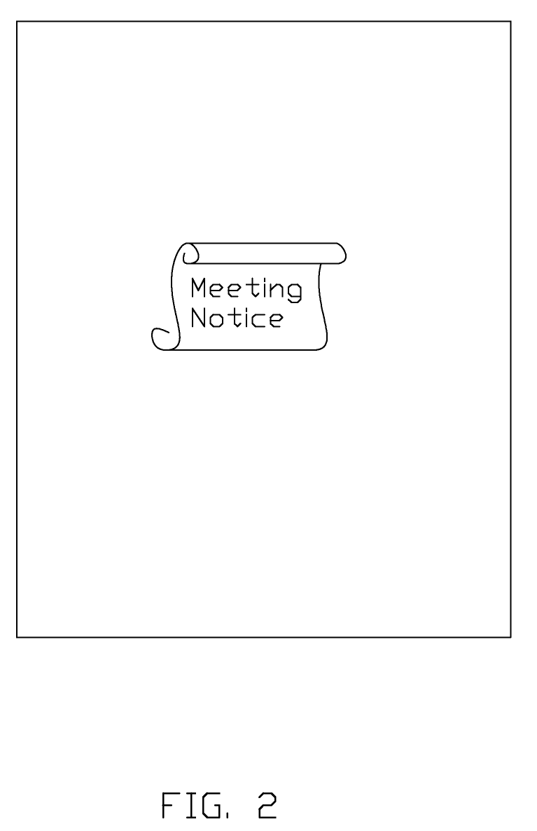

The meeting UI module 32 can be executed by the processor 20 to establish a meeting UI on the screen 10. The schedule module 34 is associated with a plurality of types of meeting information on a calendar. The plurality of types of meeting information can be recorded by the schedule module 34. Referring to FIG. 2, a notice may be shown when a meeting in the schedule module 34 is coming. The input module 36 can input characters on the meeting UI. The meeting UI module 32 includes a meeting information display sub-module 322 and an application control sub-module 324.

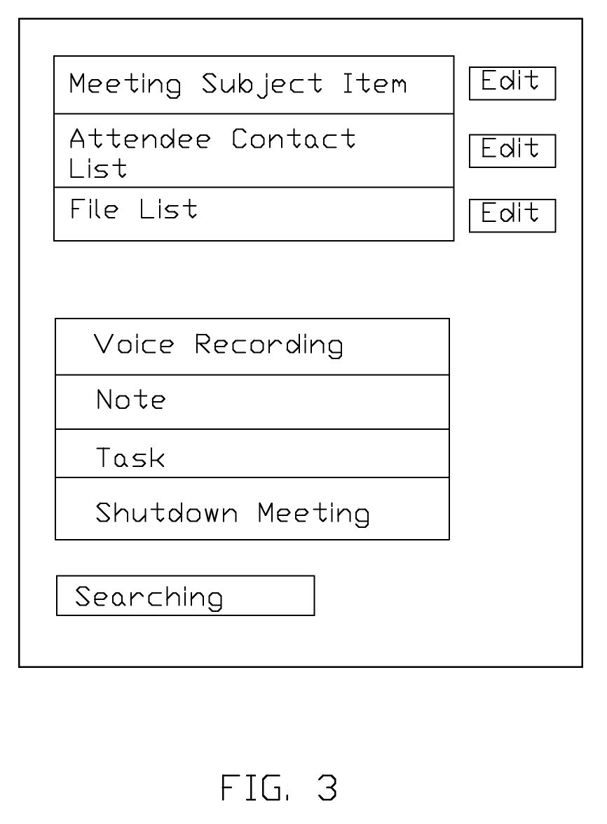

Referring to FIG. 3, the meeting UI is established on the screen 10.

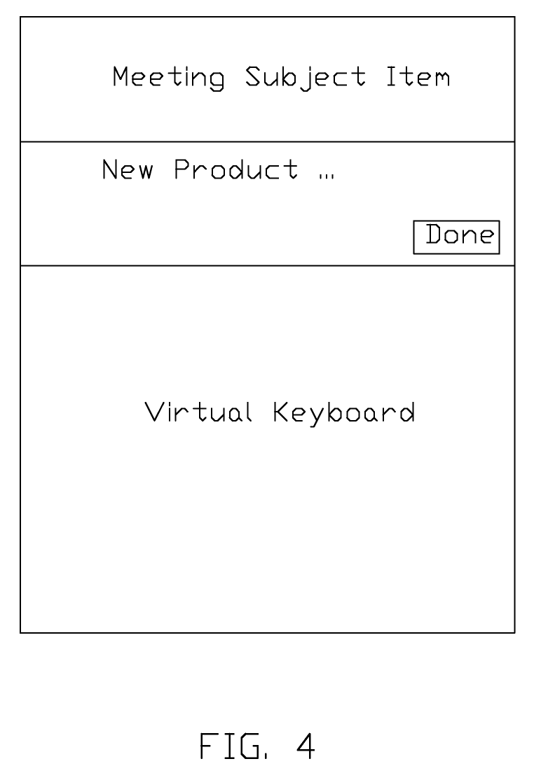

Displayed on the meeting UI on a desktop of the display screen 10 are display meeting subject items, an attendee contact list and a file list. The display meeting subject items, the attendee contact list and the file list are established by executing the meeting information display sub-module 322 by the processor 20. The display meeting subject item displays information of a past, present or a forthcoming meeting subject or agenda. Referring to FIG. 4, when a user touches the display meeting subject item, an edit window, and a virtual keyboard, which the input module is invokes may be shown. A “Done” button serves to close the edit window and the virtual keyboard.

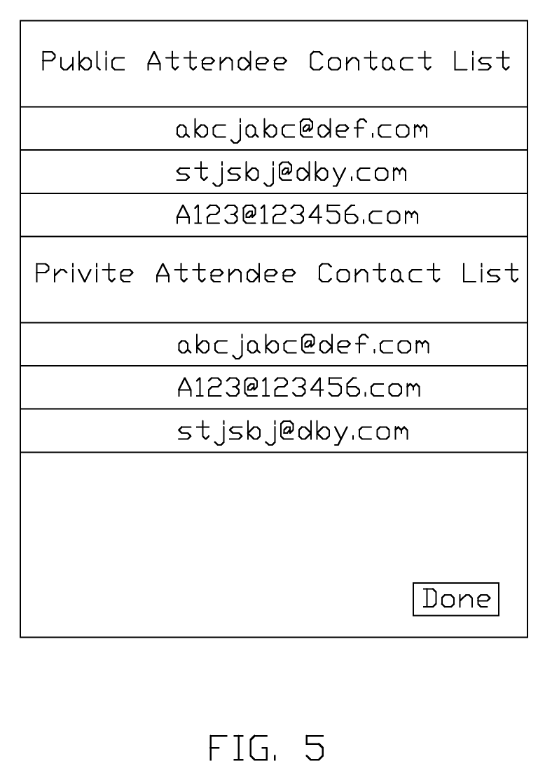

Referring to FIG. 5, the attendee contact list may display abstract attendee information of the meeting. Detail attendee contact list may be shown when the attendee contact list is pressed. The detail attendee contact list may include email addresses list, or telephone numbers list. The detail attendee contact list may include a public attendee contact list and a private attendee contact list. The public attendee contact list may share with the attending members listed in a public attendee list. The private attendee contact list is stored in the storage unit 30 for private use. An “Edit” button serves to edit the attendee contact list.

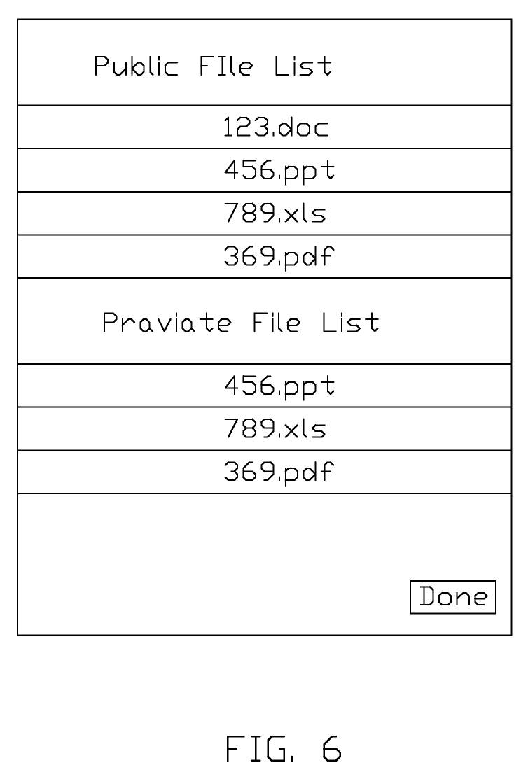

Referring to FIG. 6, the file list may display the file list of the meeting when the file list is pressed. The file list may include a public file list or a private file list. The public file list may be shared with other attending members in the public attendee list. The private file list is stored in the storage unit 30 for private use. An “Edit” button serves to edit the file list.

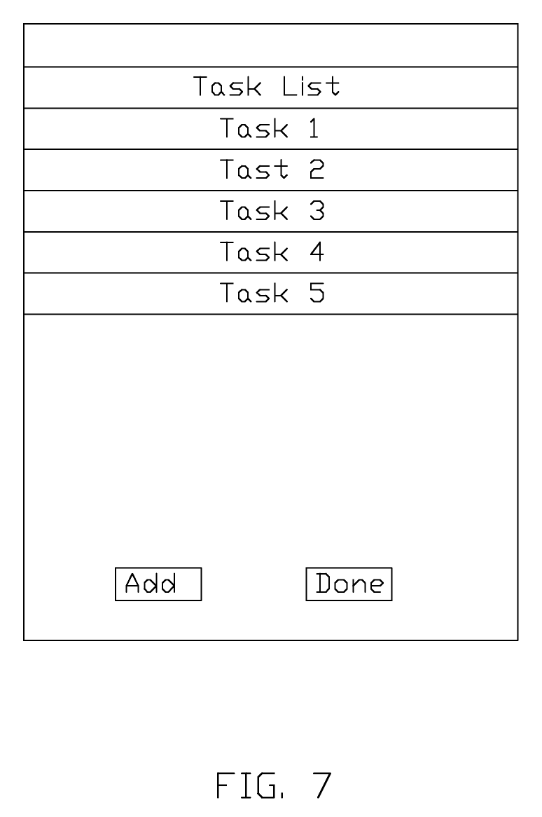

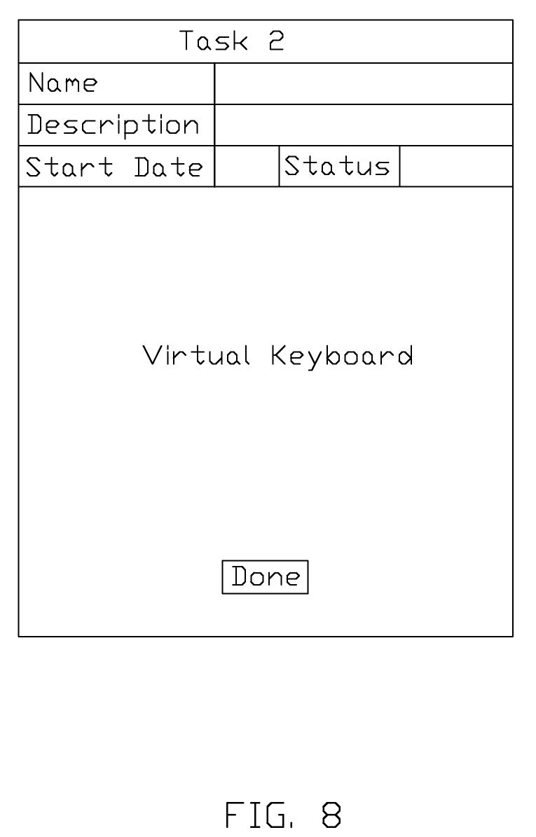

A plurality of shortcuts is established on the desktop of the display screen 10. The shortcuts may be associated with a voice recording application, a note application, a task editing application, a shutdown application, and a search application. The note application may record temporary information, such as remarks, or key words. Referring to FIG. 7, the task editing application may manage tasks established by a meeting member. All tasks may be listed when task editing application is executed. The tasks are shared through a network to the meeting members on the attendee contact list. Referring to FIG. 8, detail task information may be shown by clicking on one of the tasks in the task list.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device, comprising:
a screen;
a processor;
a storage unit storing one or more computerized instructions, wherein the storage unit comprises:
a meeting user interface (UI) module comprising a meeting information display sub-module and an application control sub-module; the meeting information display sub-module is adapted to display a meeting subject item, an attendee contact list and a file list on a desktop of the screen, and the application control sub-module is adapted to display shortcuts on the desktop of the screen, the shortcuts are associated with a voice recording application, a note application, and a task editing application.

2. The electronic device of the claim 1, wherein the storage unit further comprises a schedule module, the schedule module is associated with a plurality of types of meeting information, and the plurality of types of meeting information display sub-module is adapted to display notice of meeting information on setting time.

3. The electronic device of the claim 1, wherein the note application is adapted to record temporary information.

4. The electronic device of the claim 1, wherein the task editing application is adapted to manage tasks, and the tasks are shared through network to meeting members in the attendee contact list.

5. The electronic device of the claim 1, wherein the file list are shared to meeting members in the attendee contact list.

6. The electronic device of the claim 1, wherein the storage unit further comprises an input module for inputting characters.

7. The electronic device of the claim 6, wherein the meeting UI module is adapted to invoke the input module to modified the meeting subject item, the attendee contact list or the file list.

8. A computer-implemented method comprising:
presenting a meeting subject item, an attendee contact list and a file list on a desktop of the screen;
displaying a plurality of shortcuts on the desktop; and
associating each of the plurality of shortcuts to at least a voice recording application, a note application, and a task editing application respectively.

9. The method of the claim 8 further comprising associating a plurality of meeting information to a schedule module, and displaying notice of meeting information on setting time.

10. The method of the claim 8, wherein the note application is adapted to record information.

11. The method of the claim 8, wherein the task editing application manages tasks, and shares the tasks through network to meeting members in the attendee contact list.

12. The method of the claim 8, wherein the file list are shared to meeting members in the attendee contact list.

13. The method of the claim 8 further comprising invoking an input module to modified the meeting subject item, the attendee contact list or the file list.

14. A storage medium having stored thereon instructions that, when executed by a processor, causing the processor to perform a method for providing a user interface on a screen of an electronic device, wherein the method comprises:
presenting a meeting subject item, an attendee contact list and a file list on a desktop of the screen;
displaying a plurality of shortcuts on the desktop; and
associating each of the plurality of shortcuts to voice recording application, a note application, and a task editing application.

15. The storage medium of the claim 14, wherein the method further comprises associating a plurality of meeting information to a schedule module, and displaying notice of meeting information on setting time.

16. The storage medium of the claim 14, wherein the note application is adapted to record information.

17. The storage medium of the claim 14, wherein the task editing application is adapted to manage tasks, and the tasks are shared through network to meeting members in the attendee contact list.

18. The storage medium of the claim 14, wherein the file list are shared to meeting members in the attendee contact list.

19. The storage medium of the claim 14, wherein the method further comprises invoking an input module to modified the meeting subject item, the attendee contact list or the file list.
